(19) United States
(12) Patent Application Publication
(10) Pub. No.: US 2005/0257159 A1
(43) Pub. Date: Nov. 17, 2005

(54) Method and apparatus for identifying attachments in an email message

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/845,539

(22) Filed: May 13, 2004

(51) Int. Cl. G06F 9/00

(52) U.S. Cl. 715/752; 709/206

(57) ABSTRACT

A method, apparatus, and computer instructions for processing email messages in a data processing system. A determination is made as to whether a set of attachments is associated with an email message. If a set of attachments is associated with the email message, an indicator is added to a subject line for the email message for each type of attachment in the set of attachments associated with the email message. The indicator provides an indication of a type of attachment associated with the email message and the indicator is displayed with the subject line in a folder of an email program.

### BACKGROUND OF THE INVENTION

1. Technical Field

The present invention relates generally to an improved data processing system. In particular, the present invention relates to an improved method, apparatus, and computer instructions for processing data. Still more particularly, the present invention provides a method, apparatus, and computer instructions for identifying attachments in electronic mail in a data processing system.

2. Description of Related Art

Email allows a person to quickly and easily send textual messages and other information, such as, for example, pictures, sound recordings, and formatted documents electronically to other email users anywhere in the world. An email system typically involves a server-based mail program residing on a server computer to manage the exchange of email messages over one or more networks and a client-based email program residing on the client to implement a mail box that receives and holds the email messages for a user. Typically, these client-based programs also include a graphical user interface to enable a user to easily and conveniently open and read email messages in addition to creating new email messages.

An email user will typically create a message using an email program running on a computer connected to a computer network, such as a local area network (LAN), a wide area network (WAN), or the Internet. The message will include an email “address” for the intended recipient. When the user has finished entering the message, the user may “send” the message to the intended recipient. The email program then electronically transmits the message over the computer network. The recipient, using an email program running on the recipient's computer, can then “receive” the message.

In many cases, a user may send one or more attachments to a recipient. These attachments include, for example, word processing documents, images, spreadsheet files, executable files, and audio files. Of course, any type of file may be associated with an email message as an attachment. In some cases, a recipient may know that a particular type of attachment has been received, but is unable to find that type of attachment. For example, a recipient may know that a spreadsheet was received, but is unable to find the email message with the spreadsheet because of the large number of messages that the recipient has received. In this situation, the recipient is required to open each email message to display the attachments associated with the email messages. This process can be tedious and time consuming if the recipient has received a large number of messages with attachments.

Therefore, it would be advantageous to have an improved method, apparatus, and computer instructions for indicating types of attachments associated or attached to email messages in a folder without requiring a user to open or read the email to identify the attachments.

### SUMMARY OF THE INVENTION

The present invention provides a method, apparatus, and computer instructions for processing email messages in a data processing system. A determination is made as to whether a set of attachments is associated with an email message. If a set of attachments is associated with the email message, an indicator is added to a subject line for the email message for each type of attachment in the set of attachments associated with the email message. The indicator provides an indication of a type of attachment associated with the email message and the indicator is displayed with the subject line in a folder of an email program.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating an exemplary electronic mail messaging system in accordance with a preferred embodiment of the present invention;

FIGS. 5A and 5B are diagrams illustrating indicator features in accordance with a preferred embodiment of the present invention;

FIG. 6 is a flowchart of a process for processing email attachments in email messages in accordance with a preferred embodiment of the present invention; and

FIG. 7 is a flowchart of a process for displaying attachments in accordance with a preferred embodiment of the present invention.

### DETAILED DESCRIPTION OF THE PREFERRED EMBODIMENT

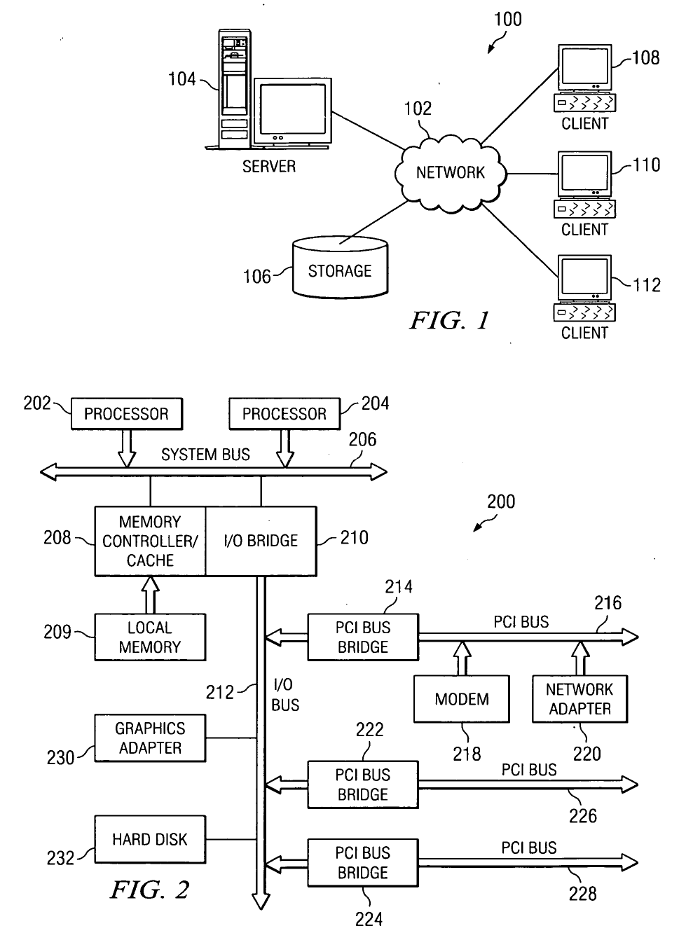

With reference now to the figures, FIG. 1 depicts a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers or personal digital assistants (PDA) devices. In the depicted example, server 104 provides data, such as boot files, operating system images, and applications to clients 108-112. Clients 108, 110, and 112 are clients to server 104. Server 104 may act as an instant messaging server to facilitate the exchange of messages between users at clients, such as clients 108, 110, and 112. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

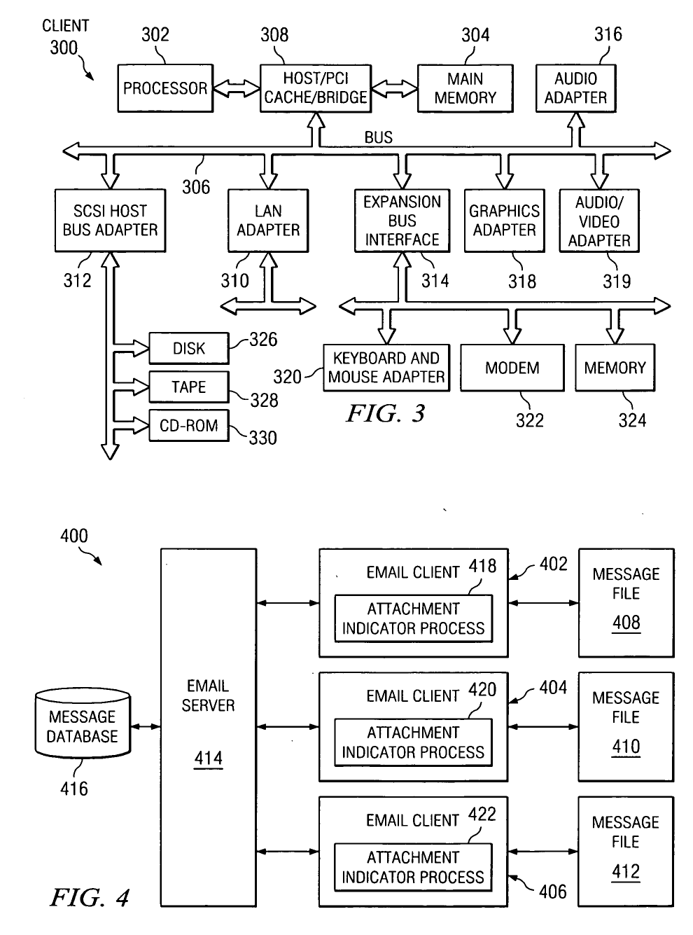

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention provides an improved method, apparatus, and computer instructions for handling email messages that have attachments associated with them. The mechanism of the present invention identifies attachments associated with email messages. Indicators, such as ASCII characters or graphical indicators may be used to generate an indication of the type of attachment associated with an email message. These indicators are added to the subject line of an email message. This subject line is typically displayed in a folder, such as in an inbox in an email program. As used herein, a folder is any container or mechanism that is used to group a set of email messages for display by an email program. Through the use of indicators in the subject line, a user may quickly identify the type of attachment associated with an email message.

Turning now to FIG. 4, a diagram illustrating an exemplary electronic mail messaging system, such as electronic mail messaging system 400, is depicted in accordance with a preferred embodiment of the present invention. In this example, email client 402, email client 404, and email client 406 are email clients, programs, or applications located at different client data processing systems, such as client 108, client 110, and client 112 in FIG. 1. Message file 408, message file 410, and message file 412 are associated with these email clients. These message files serve to store email messages received by the clients and may be organized into various mailboxes. Examples of various mailboxes include, for example, an inbox, a sent folder, a deleted folder, and an outbox folder.

These email programs may employ different protocols depending upon the implementation. For example, simple mail transfer protocol (SMTP) is a standard email protocol that is based on TCP/IP. This protocol defines a message format and the message transfer agent, which stores and forwards the mail. Other protocols, such as post office protocol 3 (POP3), also may be employed.

These email programs are used to send email back and forth to different users through email server 414. Messages sent to other email clients are stored in email message database 416. When an email client connects to email server 414, any messages for that particular client are then sent to the client. Attachments to email messages may be transferred to email server 414 for delivery with the email messages.

Email clients 402, 404, and 406 may be implemented using presently available email clients with an additional process or feature in which these clients now look for email type designation as described above.

Further, the mechanism of the present invention includes a process for identifying the types of attachments associated with or attached to email messages. When the type of email attachment is identified, an indicator associated with the type of attachment is added to the subject line such that this indicator is displayed to a user in an email client. If an email message has more than one type of attachment, more than one indicator is used to identify these attachments in these illustrative examples.

This process may identify the type of attachment based on the extension for the file. For example, a word document is identified by an extension “.doc”, while a Adobe file has an extension “.pdf”. In these illustrative examples, this process is implemented in attachment indicator processes 418, 420, and 422, which are located in email clients 402, 404, and 406.

Of course this process could be implemented elsewhere, such as in email server 414. In this type of implementation, email server 414 would identify attachments for email messages received for delivery and add indicators to the subject lines before delivering these messages to the email clients.

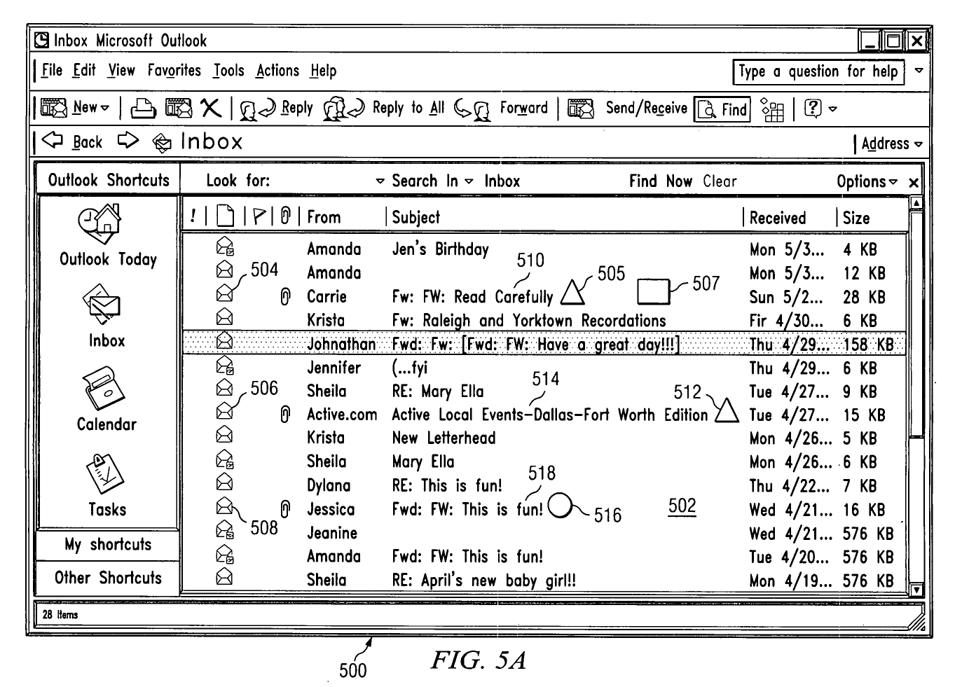

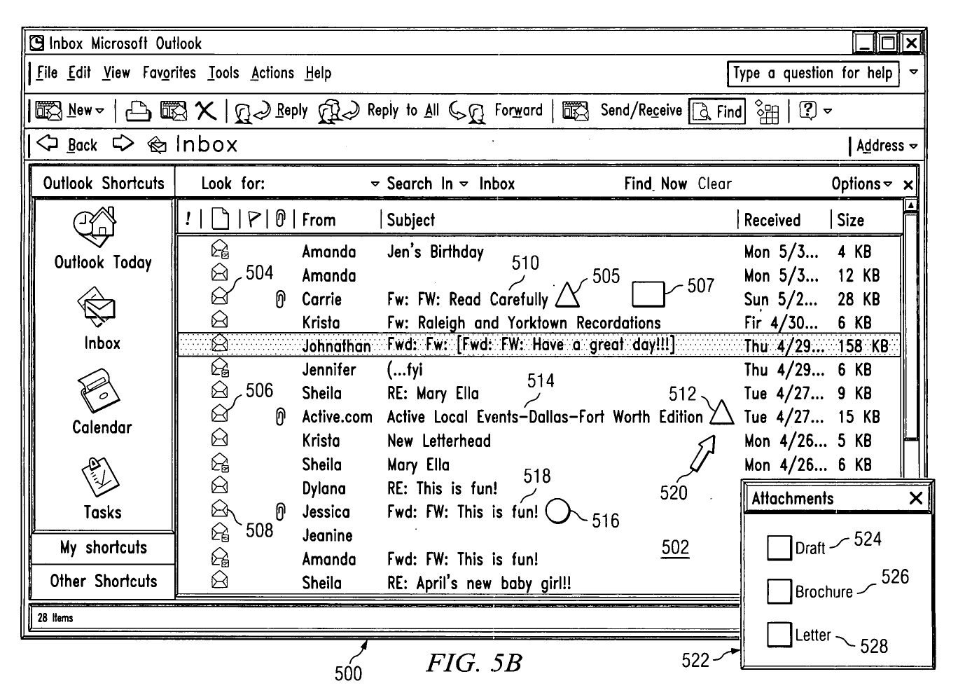

Turning now to FIGS. 5A and 5B, diagrams illustrating indicator features are depicted in accordance with a preferred embodiment of the present invention. In FIG. 5A, email client 500 is shown in which a folder, such as inbox 502, is displayed to the user. Email client 500 may be implemented as email client 402 in FIG. 4.

In this illustrative example, email messages 504, 506, and 508 have attachments. In accordance with an illustrative embodiment of the present invention, indicators have been added to the subject lines of these messages. More specifically, indicator 505 and indicator 507 have been added to subject line 510 of email message 504. Indicator 512 has been added to subject line 514 of email message 506, and indicator 516 has been added to subject line 518 of email message 508. In these examples, these indicators take the form of graphical indicators or icons. A different type of indicator is used for each type of attachment in these examples. For example, indicator 505 and indicator 512 may be used to identify a type of attachment that takes the form of a word processing document. Indicator 507 may identify a spreadsheet as the type of attachment, while indicator 516 identifies the type of attachment as an image.

In FIG. 5B, the user has moved pointer 520 into the proximity of or over indicator 512. This causes pop up window 522 to be displayed to the user. Pop up window 522 shows three word processing documents, draft 524, brochure 526, and letter 528. Selection of these documents from pop up window 522 may be made to open the attachment directly from pop up window 522 without requiring a user to open email message 506.

In this manner, a user is able to identify the different types of attachments associated with email messages in a folder such as inbox 502, without having to open the messages to identify the attachments. The mechanism of the present invention may be applied to email messages stored in any folder in an email program.

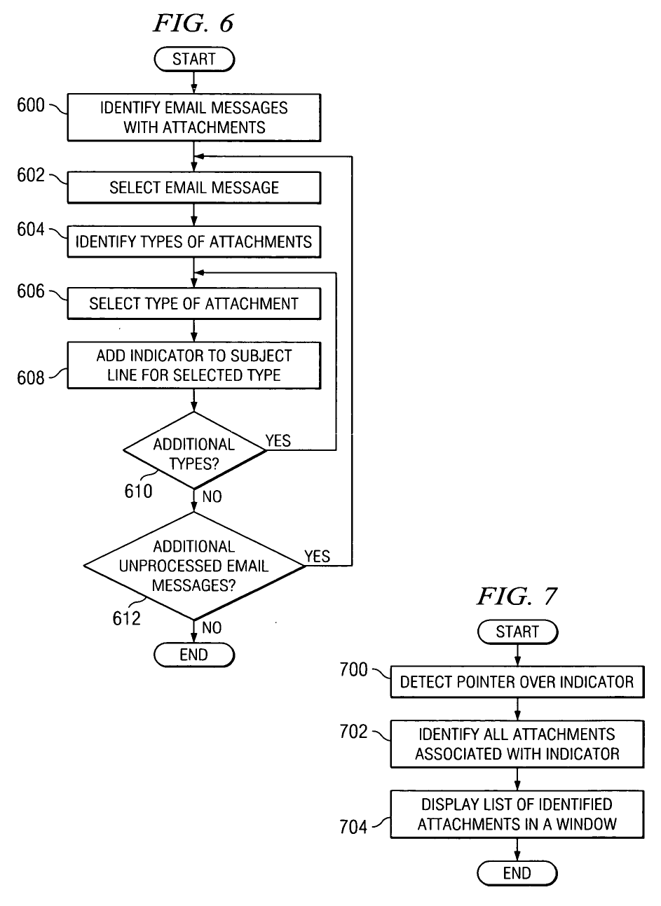

With reference now to FIG. 6, a flowchart of a process for processing email attachments in email messages is depicted in accordance with a preferred embodiment of the present invention. The process illustrated in FIG. 6 may be implemented in an email client, such as email client 402 in FIG. 4. More specifically, this process may be implemented in attachment indicator process 418 in FIG. 4.

The process begins by identifying email messages with attachments (step 600). Next, an identified email message is selected (step 602). Then, types of attachments are identified for the selected email message (step 604). The email message may have more than one type of attachment or may have a single attachment with a single type of attachment.

Next, a type of attachment is selected for processing (step 606). Then, an indicator is added to the subject line for the selected type of attachment (step 608). Next, a determination is made as to whether there are additional types of attachments that have not been processed (step 610). If additional types of attachments are not present, a determination is made as to whether additional identified email messages that have not been processed are present (step 612). If additional unprocessed email messages are not present, the process terminates thereafter.

Referring back to step 610, if additional types of attachments are present for processing, the process proceeds to step 606 as described above. In step 612, if additional unprocessed email messages are present, then the process proceeds to step 602 as described above.

With reference now to FIG. 7, a flowchart of a process for displaying attachments is depicted in accordance with a preferred embodiment of the present invention. The process illustrated in FIG. 7 may be implemented in an email client, such as email client 402 in FIG. 4. More specifically, this process may be implemented in attachment indicator process 418 in FIG. 4.

The process begins by detecting a pointer over a indicator (step 700). Depending on the particular implementation, the pointer may not be over the indicator, but within a selected distance or within a selected region, such as the subject line containing the indicator. Next, all attachments associated with the indicator are identified (step 702). Then, a list of identified attachments in a window is displayed (step 704) with the process terminating thereafter. These attachments may be displayed using a window, such as pop up window 522 in FIG. 5.

Thus, the present invention provides an improved method, apparatus, and computer instructions for identifying attachments to email messages. The mechanism of the present invention adds one or more indicators, such as icons, to the subject line of email messages containing attachments. In the illustrative examples, different indicators are used to identify different types of attachments. In this manner, the mechanism of the present invention allows a user to quickly identify the types of attachments associated with email messages in a folder, such as an inbox. This mechanism allows the user to identify the attachments without having to open the email message.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a data processing system for processing email messages, the method comprising:
determining whether a set of attachments is associated with an email message within a plurality of email messages being displayed in an email program; and
if the set of attachments is associated with the email message, adding an indicator to a subject line for the email message for each type of attachment in the set of attachments associated with the email message, wherein the indicator provides an indication of a type of attachment associated with the email message and wherein the indicator is displayed with the subject line of the email message within the plurality of email messages being displayed by the email program.

2. The method of claim 1 further comprising:
responsive to a pointer being within a selected distance of the indicator, identifying each attachment in the set of attachments of the type of attachment that the indicator provides to form a list of attachments; and
displaying the list of attachments associated with the indicator.

3. The method of claim 2 further comprising:
responsive to a selection of a particular attachment from the list of attachments, launching an application for the attachment.

4. The method of claim 1, wherein the determining step is initiated in response to receiving the email message.

5. The method of claim 1, wherein the set of attachments is a single attachment.

6. The method of claim 1, wherein the type of attachment is one of a word processing document, a spreadsheet, an executable file, or an image.

7. The method of claim 1, wherein the determining step is initiated in response to receipt of the email message by the email program.

8. The method of claim 1, wherein the email message and the indicator are located in an inbox folder of the email program.

9. A data processing system for processing email messages, the data processing system comprising:
determining means for determining whether a set of attachments is associated with an email message within a plurality of email messages being displayed in an email program; and
adding means for adding an indicator to a subject line for the email message for each type of attachment in the set of attachments associated with the email message, if the set of attachments is associated with the email message, wherein the indicator provides an indication of a type of attachment associated with the email message and wherein the indicator is displayed with the subject line of the email message within the plurality of email messages being displayed by the email program.

10. The data processing system of claim 9 further comprising:
identifying means, responsive to a pointer being within a selected distance of the indicator, for identifying each attachment in the set of attachments of the type of attachment that the indicator provides to form a list of attachments; and
displaying means for displaying the list of attachments associated with the indicator.

11. The data processing system of claim 10 further comprising:
launching means, responsive to a selection of a particular attachment from the list of attachments, for launching an application for the attachment.

12. The data processing system of claim 9, wherein the determining means is initiated in response to receiving the email message.

13. The data processing system of claim 9, wherein the set of attachments is a single attachment.

14. The data processing system of claim 9, wherein the type of attachment is one of a word processing document, a spreadsheet, an executable file, or an image.

15. The data processing system of claim 9, wherein the determining means is initiated in response to receipt of the email message by the email program.

16. The data processing system of claim 9, wherein the email message and the indicator are located in an inbox folder of the email program.

17. A computer program product in a computer readable medium for processing email messages, the computer program product comprising:
first instructions for determining whether a set of attachments is associated with an email message within a plurality of email messages being displayed in an email program; and
second instructions for adding an indicator to a subject line for the email message for each type of attachment in the set of attachments associated with the email message, if the set of attachments is associated with the email message, wherein the indicator provides an indication of a type of attachment associated with the email message and wherein the indicator is displayed with the subject line of the email message within the plurality of email messages being displayed by the email program.

18. The computer program product of claim 17 further comprising:
third instructions, responsive to a pointer being within a selected distance of the indicator, for identifying each attachment in the set of attachments of the type of attachment that the indicator provides to form a list of attachments; and
fourth instructions for displaying the list of attachments associated with the indicator.

19. The computer program product of claim 18 further comprising:
fifth instructions, responsive to a selection of a particular attachment from the list of attachments, for launching an application for the attachment.

20. The computer program product of claim 17, wherein the first instructions is initiated in response to receiving the email message.

21. The computer program product of claim 17, wherein the set of attachments is a single attachment.

22. The computer program product of claim 17, wherein the type of attachment is one of a word processing document, a spreadsheet, an executable file, or an image.

23. The computer program product of claim 17, wherein the first instructions is initiated in response to receipt of the email message by the email program.

24. The computer program product of claim 17, wherein the email message and the indicator are located in an inbox folder of the email program.

25. A data processing system comprising:
a bus system;
a memory connected to the bus system, wherein the memory includes a set of instructions; and
a processing unit connected to the bus system, wherein the processing unit executes the set of instructions to determine whether a set of attachments is associated with an email message within a plurality of email messages being displayed in an email program; and add an indicator to a subject line for the email message for each type of attachment in the set of attachments associated with the email message if the set of attachments is associated with the email message, wherein the indicator provides an indication of a type of attachment associated with the email message and wherein the indicator is displayed with the subject line of the email message within the plurality of email messages being displayed by the email program.
